(19) United States
(12) Patent Application Publication
(10) Pub. No.: US 2012/0044036 A1
(43) Pub. Date: Feb. 23, 2012

(54) Safety Unit Integrated on a Printed Circuit Board and the Printed Circuit Board

(75) Inventor: Wei Shang, Pudong Shanghai (CN)

(73) Assignee: EBM-PAPST VENTILATOR (SHANGHAI) CO., LTD., Pudong Shanghai (CN)

(21) Appl. No.: 13/205,777

(22) Filed: Aug. 9, 2011

(30) Foreign Application Priority Data
Aug. 19, 2010 (CN) 201020298676.0

(51) Int. Cl. H01H 85/20

(52) U.S. Cl. 337/186

(57) ABSTRACT

The invention provides a safety unit integrated on a PCB (printed circuit board) and the PCB, and pertains to the technical field of circuit protecting device. The safety unit comprises: first electrode terminals; copper wire connected to the first electrode terminals at both ends respectively; an insulating paint film covering the copper wire; a chip fixed resistor disposed on the insulating paint film; and second electrode terminals connected to both ends of the chip fixed resistor respectively; wherein the first electrode terminals, the second electrode terminals and the copper wire are firmly pressed to be fixed onto the substrate of the printed circuit board. The safety unit provided by the invention possesses such characteristics as being simple in structure, low in cost and small in volume.

### CROSS-REFERENCE TO RELATED APPLICATIONS

The present application claims priority to pending Chinese Patent Application No. 201020298676.0, filed Aug. 19, 2010, the contents of which are incorporated by reference in its entirety.

### FIELD OF THE INVENTION

The invention pertains to the technical field of circuit protecting device, in particular to a safety unit integrated on a printed circuit board (PCB), as well as the printed circuit board.

### BACKGROUND

The fuse wire is circuit unit commonly used in a circuit protecting device. According to the characteristics of fuse wire products, there can be a variety of fuse wires, such as a delay fuse wire, a high speed fuse wire, an anti-explosion fuse wire, an anti arc spark fuse wire, etc. However, in common products, fuse wires of universal type have come into the most widespread use in order to realize circuit protection.

Generally, the fuse wire of universal type has a relatively sealed cavity, the interior of which is connected to two electrodes via a segment of metal wire; when the current is too large, the fuse wire inside the cavity will fuse. The fusing duration of the fuse wire of universal type is typically of a medium length, and the arc extinguishing performance and anti-explosion performance thereof are not prominent. The reasons why the fuse wire of universal type is widely used in electronic industry (in particular, in a low voltage and low power application) are based on considerations of various aspects. However, there are two main aspects: firstly, the fuse wires of the universal type can already meet the demands of most circuit protection applications; and secondly, the fuse wires of the universal type are low in cost and technical demands.

Nevertheless, fuse wires of the universal type are not suitable for certain circumstances. For example, in a highly integrated electronic component, the demand of narrow space usually makes the universal type fuse wires not applicable. Generally, in such conditions (for example, on a PCB with highly dense components), a fuse wire having a small size is applied. However, the small size fuse wire is relatively high in cost.

Actually, the metal wires inside the cavity of the universal type fuse wires mostly consist of coherer (such as copper wire(s)); the core principle is to use copper wire(s) that is relatively small in diameter, which is then sealed in a small cavity to achieve fundamental functions of fuse wire with such problems as heat emission and electric arc taken into consideration.

It is also noted that in a PCB (printed circuit board), generally, a lay of copper metal film is heat stamped onto an insulating substrate, and then a certain circuit is formed by eroding the layer of copper metal film.

In view of the above and in combination with the structural characteristics of the PCB itself, a novel safety unit having a small volume is proposed.

### SUMMARY

The main object of the invention is to provide a safety unit which is simple in structure, small in volume, and low in cost.

In order to achieve the above or other objects, the invention provides the following technical solution.

According to one aspect of the invention, a safety unit integrated on a printed circuit board in provided, comprising:
first electrode terminals;
copper wire connected to the first electrode terminals at both ends respectively;
an insulating paint film covering the copper wire;
a chip fixed resistor disposed on the insulating paint film; and
second electrode terminals connected to both ends of the chip fixed resistor respectively;
   wherein the first electrode terminals, the second electrode terminals and the copper wire are firmly pressed to be fixed onto the substrate of the printed circuit board.

As a preferred technical solution, the edge of contacting portion between the first electrode terminals and the copper wire is connected with the side edge of the copper wire in a gradual varying manner in shape.

Specifically, the edge of contacting portion between the first electrode terminals and the copper wire can be arranged to be gradual varying linear structure; the edge of contacting portion between the first electrode terminals and the copper wire can also be arranged to be gradual varying arc structure; and the side edge of the copper wire and the arc are connected tangent to each other.

As a preferred technical solution, the first electrode terminals, the second electrode terminals, the copper wire and the circuit on the PCB are formed by patterning the same layer of copper metal film covering the substrate. The insulating paint film and the insulating paint film covering the circuit of the PCB are formed by patterning the same layer of insulating paint film. The insulating paint film is square in shape. The side length of the square is the same as the length of the copper wire.

Specifically, the copper wire perpendicularly joints the chip fixed resistor.

According to another aspect of the invention, a PCB comprising any of the above-mentioned safety units is provided.

The technical effect brought about by the invention lies in that the safety unit provided by the invention possesses such characteristics as being simple in structure, low in cost and small in volume, making it highly applicable to PCBs with densely distributed components.

### BRIEF DESCRIPTION OF THE DRAWINGS

The above and other objects and advantages of the invention will be more fully understood from the following description with reference to the accompanying drawings, wherein the same or like elements are indicated by the same reference sign.

FIG. 1 is a schematic structural view of an embodiment of the safety unit provide by the invention;

FIG. 2 is a schematic structural view of another embodiment of the safety unit provided by the invention.

### DETAILED DESCRIPTION OF THE EMBODIMENTS

Some of the many possible embodiments of the invention will be described hereinafter, in order to provide a basic understanding of the invention and not to confirm the key points of the invention or decisive elements or limit the claimed scope of protection.

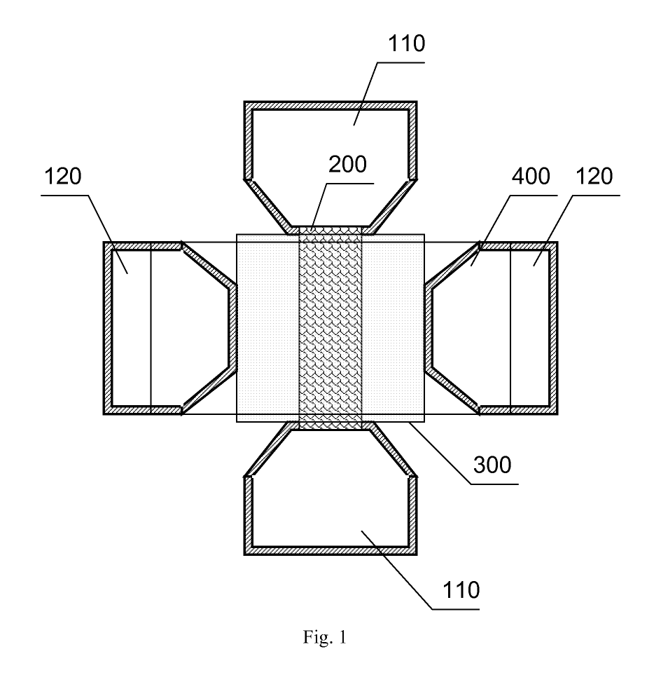

FIG. 1 is a schematic structural view of an embodiment of the safety unit provided by the invention. In the invention, the safety unit is integrated onto a PCB (not shown). As shown in FIG. 1, the safety unit comprises first electrode terminals 110 and copper wire 200, and the two ends of the copper wire 200 are connected with the first electrode terminals 110 respectively. In practical use, the first electrode terminals 110 serve as the input end or output end of the limited current so that the limited current (i.e., the current carrying capacity of the copper wire) flows through the copper wire. The shape of the copper wire 200 can be specifically designed according to such parameters as the amount of the current carrying capacity, the response time, etc. For example, when the copper wire 200 is designed to be a linear shape, the thickness H and width W of the copper wire 200 is designed according to the specific requirements on the parameter of the amount of the current carrying capacity, and the length L of the copper wire 200 is designed according to the specific requirements on the parameter of response time. Both the copper wire 200 and the first electrode terminals 110 are formed by a copper metal film. Generally, a circuit formed by patterning a copper metal film is also firmly pressed to be fixed on the PCB. Therefore, the copper wire 200, the first electrode terminals 110 and the circuit on the PCB may be preferably formed by patterning the same layer of copper metal film covering the substrate and the specific patterning method is not restricted by the invention. In this manner, the copper wire 200 and the first electrode terminals 110 are also firmly pressed to be fixed onto the substrate of the PCB without additional process steps to form the safety unit, resulting in a low manufacture cost.

Still with reference to FIG. 1, the intersection between the copper wire 200 and the first electrode terminals 110 does not necessarily have an apparent boundary as shown in the figure. Generally, the copper wire 200 and the first electrode terminals 110 are connected to be integral. By designing the shape of the first electrode terminals 110, there is a gradual varying transition between the first electrode terminals 110 and the copper wire 200 in shape. In this embodiment, the edge of contacting portion between the first electrode terminals 110 and the copper wire 200 is arranged to be a gradual varying linear structure, as shown in the figure; the connecting end of the first electrode terminals 110 is arranged to be of a trapezoid shape, the shorter upper side of the trapezoid is connected to the copper wire 200 so that the first electrode terminals 110 and the copper wire 200 are connected in a gradual varying manner in shape. As such, when the limited current flows into the copper wire from one of first electrode terminals 110, the current density at the contacting portion will not change suddenly, thus avoiding electromagnetic radiation and heat accumulation caused by a sudden change in current.

Still with reference to FIG. 1, the safety unit comprises an insulating paint film 300 covering the copper wire. Since in the situation where certain current limit is exceeded in the copper wire, most of the heat generated by large current will fuse the copper wire 200 instantaneously, an explosion and gasification may occur. The insulating paint film 300 is thus used to prevent copper vapor and spark splashing caused when the copper wire 200 explode instantaneously at a large current. Of course, the insulating characteristic of the insulating paint film 300 can also be used to prevent the copper wire from being electrically connected to other components (e.g., the other e components on the PCB) than the first electrode terminals 110. In this embodiment, the insulating paint film 300 is designed to be of a square shape. The side length of the square is substantially the same as the length of the copper wire so as to cover the copper wire 200 in a whole. Since the PCB is generally also covered with a layer of insulating paint film on the circuit thereof during the manufacture of PCB, the insulating paint film 300 and the insulating paint film covering the circuit on the PCB are formed by patterning the same layer of insulating paint film. Thus, the manufacturing cost of the safety unit is lowered.

Still reference to FIG. 1, the safety unit comprises a chip fixed resistor 400 disposed on the insulating paint film 300 and second electrode terminals 120 connected with two ends of the chip fixed resistor 400 respectively. Preferably, two second electrode terminals 120 are located on two sides of the copper wire 200 respectively so that the chip fixed resistor 400 perpendicularly joints the copper wire 200. The second electrode terminals 120 are also firmly pressed to be fixed on the substrate (not shown) of the PCB. The second electrode terminals 120 can be formed synchronously with the first electrode terminals 110 and the copper wire 200 by patterning. Preferably, the copper wire 200, the first electrode terminals 110, the second electrode terminals 120 and the circuit on the PCB are formed by patterning the same layer of copper metal film covering the substrate. The specific patterning method is not restricted by the invention. Thus, no additional process steps to form the safety unit are required, resulting in a low manufacture cost.

The chip fixed resistor 400 can indirectly cover the copper wire 200 by being arranged on the insulating paint film 300. The chip fixed resistor 400 is arranged to be of a rectangle shape. The two ends in the length direction of the chip fixed resistor 400 are lapped on the second electrode terminals 120. In this embodiment, the dimension of the rectangle is smaller than the dimension of the insulating paint film 300 in the width direction (i.e., the length direction of the copper wire). Similarly, since in the situation where certain current limit is exceeded in the copper wire 200, most of the heat generated by large current will fuse the copper wire 200 instantaneously, an explosion and gasification may occur. The chip fixed resistor 400 can be further used to prevent copper vapor and spark splashing caused when the copper wire 200 explodes instantaneously at a large current.

Also, in this embodiment, the shape of the second electrode terminals 120 and that of the first electrode terminals 110 are substantially the same. However, it intends not to be limiting. The insulating paint film 300 is located in a middle area surrounded by the first electrode terminals 110 and the second electrode terminals 120.

It is noted from above that the safety unit can be well integrated onto the PCB and formed synchronously during the manufacture process of PCB. It has such characteristics as being simple in structure, low in cost and small in volume, making it highly applicable to PCBs with densely distributed components.

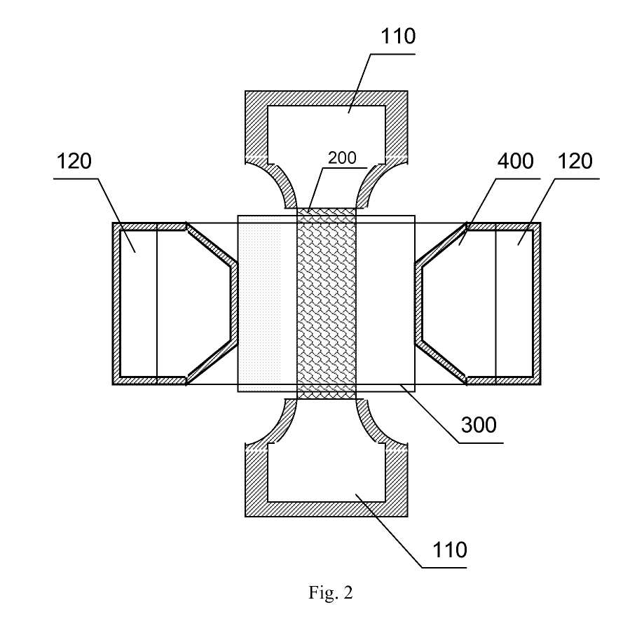

FIG. 2 is a schematic structural view of another embodiment of the safety unit provided by the invention. By comparing the safety unit of the embodiment shown in FIG. 1 and the safety unit of the embodiment shown in FIG. 2, it can be seen that the main difference lies in the variation in the design of the shape of the first electrode terminals 110. Similarly, in this embodiment, in order to avoid electromagnetic radiation and heat accumulation caused by a sudden change in current, the edge of contacting portion between the first electrode terminals 110 and the copper wire 200 is connected with the side edge of the copper wire 200 in a gradual varying manner in shape. In this embodiment, the edge of contacting portion between the first electrode terminals 110 and the copper wire 200 is arranged to be a gradual varying arc structure, as shown in the FIG. 2, the side edge of the copper wire 200 is internally tangent to the arc. The same aspects between the safety unit of the embodiment shown in FIG. 2 and that of the embodiment shown in FIG. 1 will not be discussed in detail.

It is noted although the invention provides only two embodiments to schematically describe the gradual varying connecting manner between the first electrode terminals 110 and the copper wire 200, those skilled in the art can design other shapes of gradual varying connecting manner according to the specific situation, which also fall within the spirit and scope of the invention.

The invention also provides a PCB, on which one or more safety unit descried above is integrated. The safety unit functions to realize current protection and occupies little space volume. When various chips or components are welded to the PCB to form a circuit system, the cost is lowered and space volume is saved for the system.

The above embodiments mainly discuss the safety unit and PCB thereof according to the invention. Although only some embodiments of the invention are described, it will be apparent to those skilled in the art that the invention can be implemented in many other forms without departing from the spirit and scope of the invention. Therefore, the described example and embodiment are considered to be illustrative rather than limiting. The invention can cover various modifications and equivalents without departing from the spirit and scope of the invention as defined by the appended claims.

1. A safety unit integrated on a printed circuit board, characterized in that, the safety unit comprises:
first electrode terminals;
copper wire connected to the first electrode terminals at both ends respectively;
an insulating paint film covering the copper wire;
a chip fixed resistor disposed on the insulating paint film; and
second electrode terminals connected to both ends of the chip fixed resistor respectively;
wherein the first electrode terminals, the second electrode terminals and the copper wire are firmly pressed to be fixed onto the substrate of the printed circuit board.

2. A safety unit according to claim 1, characterized in that, the edge of contacting portion between the first electrode terminals and the copper wire is connected with the side edge of the copper wire in a gradual varying manner in shape.

3. A safety unit according to claim 2, characterized in that, the edge of contacting portion between the first electrode terminals and the copper wire is arranged to be gradual varying linear structure.

4. A safety unit according to claim 2, characterized in that, the edge of contacting portion between the first electrode terminals and the copper wire is arranged to be gradual varying arc structure.

5. A safety unit according to any one of claims 1 to 4, characterized in that, the first electrode terminals, the second electrode terminals, the copper wire and the circuit on the printed circuit board are formed by patterning the same layer of copper metal film covering the substrate.

6. A safety unit according to any one of claims 1 to 4, characterized in that, the insulating paint film and the insulating paint film covering the circuit of the printed circuit board are formed by patterning the same layer of insulating paint film.

7. A safety unit according to claim 6, characterized in that, the insulating paint film is square in shape, and the side length of the square is the same as the length of the copper wire.

8. A safety unit according to any one of claims 1 to 4, characterized in that, the copper wire perpendicularly joints the chip fixed resistor.

9. A safety unit according to claim 4, characterized in that, the side edge of the copper wire and the arc are connected tangent to each other.

10. A printed circuit board, characterized by comprising a safety unit according to any one of claim 1.
